(19) United States
(12) Patent Application Publication
(10) Pub. No.: US 2026/0139940 A1
(43) Pub. Date: May 21, 2026

(54) INTEGRATED MULTIPLEXING MEASUREMENT SYSTEM

(71) Applicant: KENMEC MECHANICAL ENGINEERING CO., LTD., Taipei City (TW)

(72) Inventors: CHIH-CHUN KO, Taipei City (TW); CHIA-CHU TSENG, Taipei City (TW)

(21) Appl. No.: 19/393,592

(22) Filed: Nov. 19, 2025

(30) Foreign Application Priority Data
Nov. 20, 2024 (TW) 113144552

(51) Int. Cl. G01B 9/02015; G01B 9/02; G01B 11/30

(52) U.S. Cl. CPC G01B 9/02029; G01B 9/02027; G01B 9/02051; G01B 11/30; G01B 2210/56

(57) ABSTRACT

An integrated multiplexing measurement system for measuring semiconductor devices (compound semiconductors) includes a main body, a fringe interferometer device, a white light interferometer probe, and a color conjugate focus measurement probe. The fringe interferometer device, the white light interferometer probe, and the color conjugate focus measurement probe are disposed in the main body. The fringe interferometer device is used to measure the warpage, concavity, color, brightness distribution, shape, and distribution of high-nitrogen areas of semiconductor devices. The white light interferometer probe and the color conjugate focus measurement probe are disposed together. The white light interferometer probe measures the surface roughness and surface depth of semiconductor devices. The color conjugate focus measurement probe (dispersion probe) measures the surface roughness and thickness of semiconductor devices.

### CROSS-REFERENCE TO RELATED PATENT APPLICATION

This application claims the benefit of priority to Taiwan Patent Application No. 113144552, filed on November 20, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an integrated multiplexing measurement system, and more particularly to a semiconductor measurement system that can be used to measure semiconductor devices and that integrates multiple measurement devices.

### BACKGROUND OF THE DISCLOSURE

In recent years, third-generation semiconductors SiC and GaN have been attracting attention from relevant industries and the mass media. The largest application of third-generation semiconductors is in power semiconductor components. Recently, due to energy conservation and carbon reduction requirements, various emerging energy-saving industries such as electric vehicles, solar power generation, direct current power grids, and charging stations all require power semiconductors having high conversion efficiency.

The semiconductor manufacturing process is primarily divided into front-end and back-end processes. The front-end process is wafer manufacturing that includes crystal growth, slicing, grinding, polishing, cleaning, lithography, etching, thin film deposition, and ion implantation. The back-end process includes packaging, testing, and packing. Measurement is a crucial step in the semiconductor manufacturing process, and a semiconductor measurement apparatus can be used to measure and detect various parameters and characteristics during the semiconductor manufacturing process. This typically requires the installation of multiple measurement machines, and the measurement must be performed one-by-one sequentially by the measurement machines. Such processes are labor-intensive and time-consuming, with poor automation efficiency. Furthermore, it is not possible to conduct timely comparisons and analyses of multiple measurement results before and after these processes, such that process yield and production efficiency are difficult to be improved.

### SUMMARY OF THE DISCLOSURE

In response to the above-referenced technical inadequacies, the present disclosure provides an integrated multiplexing measurement system mainly used to improve the problems of poor object conveying lines and difficulty in improving production efficiency in the semiconductor measurement process. By integrating multiple measurement devices into one machine, the integrated multiplexing measurement system can facilitate the measurement operations of semiconductor devices and promote automated production to improve production efficiency.

In order to solve the above-mentioned problems, one of the technical aspects adopted by the present disclosure is to provide an integrated multiplexing measurement system for measuring semiconductor devices. The integrated multiplexing measurement system includes: a main body; a fringe interferometer device disposed in the main body for measuring the semiconductor device; a white light interferometer probe disposed in the main body for measuring the semiconductor device; and a color conjugate focus measurement probe disposed in the main body for measuring the semiconductor device. The white light interferometer probe is disposed adjacent to the color conjugate focus measurement probe.

In one of the possible or preferred embodiments, the fringe interferometer device is disposed in the main body and adjacent to one side of the main body, and the white light interferometer probe and the color conjugate focus measurement probe are disposed in the main body and adjacent to another side of the main body.

In one of the possible or preferred embodiments, the main body is rectangular-shaped, and two opposite sides of the main body are respectively defined as a first side and a second side; the fringe interferometer device is located adjacent to the first side of the main body, and the white light interferometer probe and the color conjugate focus measurement probe are located adjacent to the second side of the main body; and another two opposite sides of the main body are respectively defined as a third side and a fourth side, and the third side or the fourth side is an opening.

In one of the possible or preferred embodiments, the white light interferometer probe and the color conjugate focus measurement probe are spaced apart from the fringe interferometer device, and the fringe interferometer device is disposed in the main body at a position away from the white light interferometer probe and the color conjugate focus measurement probe.

The integrated multiplexed measurement system provided by the present disclosure includes a main body, a fringe interferometer device, a white light interferometer probe, and a color conjugate focus measurement probe. The fringe interferometer device, the white light interferometer probe, and the color conjugate focus measurement probe are disposed in the main body, and the white light interferometer probe and the color conjugate focus measurement probe are located adjacent to each other. The fringe interferometer device, the white light interferometer probe, and the color conjugate focus measurement probe can be separately used to measure semiconductor devices.

In the present disclosure, multiple measurement devices are integrated into a single machine, thereby facilitating the semiconductor device measurement operation and simplifying the semiconductor device conveying process, enabling rapid completion of multiple measurement operations for the semiconductor device. Measurement can be performed in-line to facilitate automated production, and semiconductor devices can be measured after different processes, so as to achieve comprehensive measurement results to enhance production efficiency, process analysis, and yield improvement. This effectively addresses issues in conventional measurement processes such as poor object conveying lines, insufficient object measurement data, and the difficulty in improving production efficiency and process yield.

These and other aspects of the present disclosure will become apparent from the following description of the embodiment taken in conjunction with the following drawings and their captions, although variations and modifications therein may be effected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective view of an integrated multiplexing measurement system according to one embodiment of the present disclosure;

FIG. 2 is a schematic front view of the integrated multiplexing measurement system according to one embodiment of the present disclosure;

FIG. 3 is a schematic top view of the integrated multiplexing measurement system according to one embodiment of the present disclosure; and

FIG. 4 is a schematic side view of the integrated multiplexing measurement system according to one embodiment of the present disclosure.

### DETAILED DESCRIPTION OF THE EXEMPLARY EMBODIMENTS

The present disclosure is more particularly described in the following examples that are intended as illustrative only since numerous modifications

and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### Embodiments

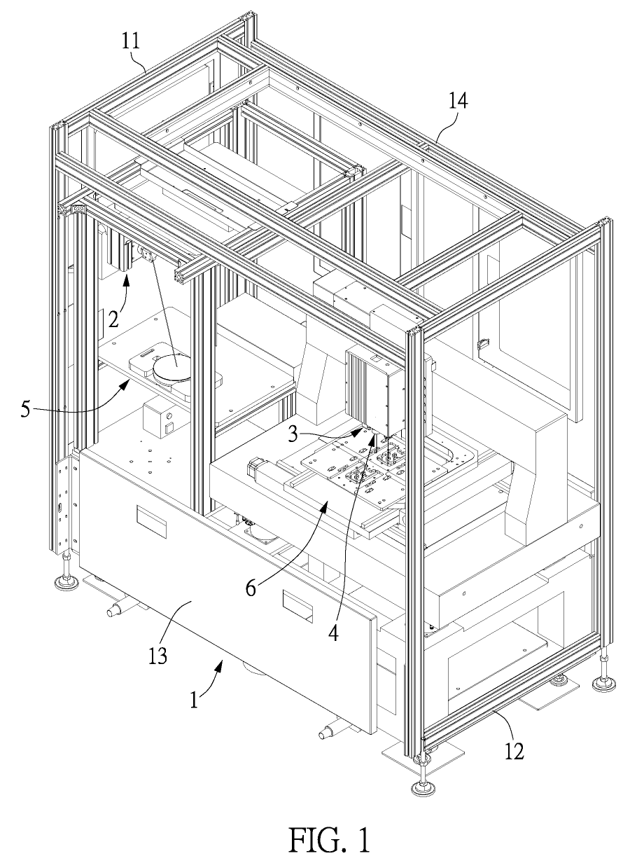

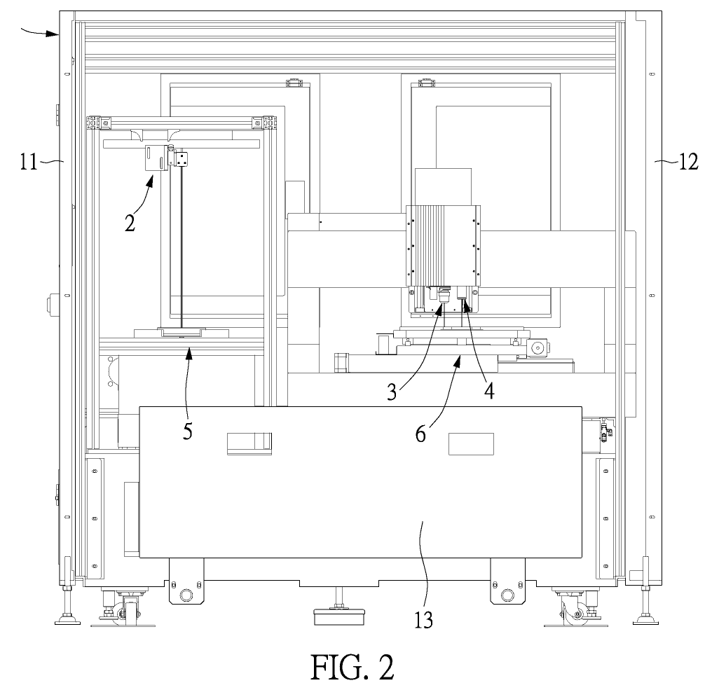

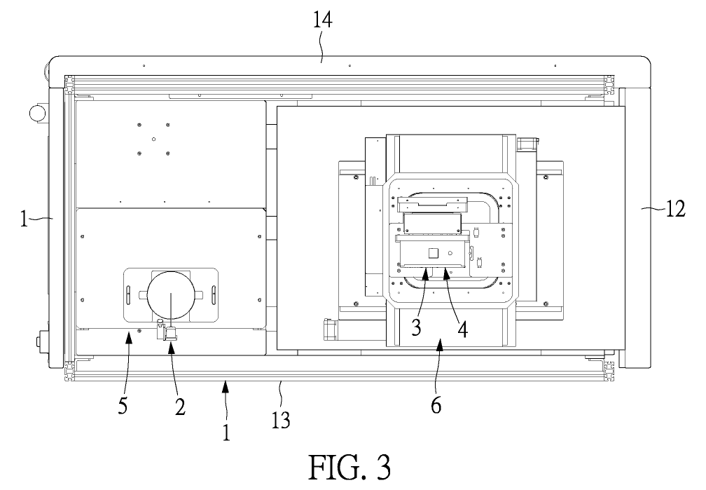

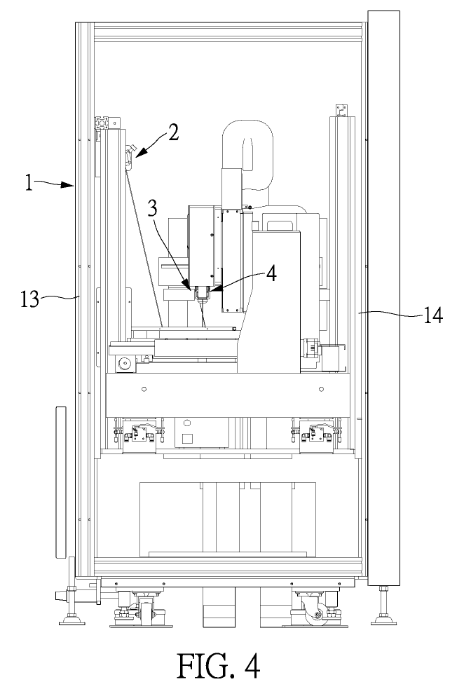

Referring to FIG. 1 to FIG. 4, the present disclosure provides an integrated multiplexing measurement system for measuring semiconductor devices (compound semiconductors). These devices may be compound semiconductors, such as third-generation semiconductors. The integrated multiplexing measurement system of the present disclosure is preferably, but not limited to, the front-end manufacturing process of compound semiconductors. The integrated multiplexing measurement system includes a main body 1, a fringe interferometer device 2, a white light interferometer probe 3, and a color conjugate focus measurement probe 4. The fringe interferometer device 2, the white light interferometer probe 3, and the color conjugate focus measurement probe 4 are disposed in the main body 1.

The fringe interferometer device 2 is disposed in the main body 1. In this embodiment, the fringe interferometer device 2 is positioned near one side (e.g., the left side) of the main body 1. A first workbench 5 can be positioned below the fringe interferometer device 2. The first workbench 5 can be used to place a semiconductor device (e.g., a wafer or an ingot) to be measured thereon. The fringe interferometer device 2 can quickly obtain information such as the overall surface shape of the semiconductor device by analyzing changes in the designed fringe patterns and interference fringes, so as to measure warpage, unevenness, color, brightness distribution, shape, and the distribution of high-nitrogen areas on the semiconductor device.

The white light interferometer probe 3 and the color conjugate focus measurement probe 4 are disposed in the main body 1, and the white light interferometer probe 3 and the color conjugate focus measurement probe 4 are disposed in one place. The white light interferometer probe 3 and the color conjugate focus measurement probe 4 are disposed adjacent to each other, and the white light interferometer probe 3 and the color conjugate focus measurement probe 4 are disposed to be spaced apart from the fringe interferometer device 2. That is, the fringe interferometer device 2 is disposed on a position in the main body 1 away from the white light interferometer probe 3 and the color conjugate focus measurement probe 4.

In this embodiment, the white light interferometer probe 3 and the color conjugate focus measurement probe 4 are disposed in the main body 1 near another side (e.g., the right side). A second workbench 6 can be disposed below the white light interferometer probe 3 and the color conjugate focus measurement probe 4. The second workbench 6 can be used to place a semiconductor device to be measured (e.g., a wafer or an ingot).

In this embodiment, the main body 1 is rectangular-shaped, and two opposite sides of the main body 1 are respectively defined as a first side 11 and a second side 12. The fringe interferometer device 2 is located adjacent to the first side 11 of the main body 1, and the white light interferometer probe 3 and the color conjugate focus measurement probe 4 are located adjacent to the second side 12 of the main body 1. This ensures an optimal configuration of the fringe interferometer device 2, the white light interferometer probe 3, and the color conjugate focus measurement probe 4. Another two opposite sides of the main body 1 are respectively defined as a third side 13 and a fourth side 14. The third side 13 or the fourth side 14 may be an opening to facilitate the input and output of semiconductor devices.

The white light interferometer probe 3 employs the principle of interferometry. By irradiating a white light source onto the surface of a semiconductor device, an interference fringe pattern is formed. By analyzing the spacing and shape of the interference fringes, the surface height differences and topographical features can be accurately measured. The white light interferometer probe 3 can measure nanometer-level surface roughness, surface depth, and micro-changes of the semiconductor device.

The color conjugate focus measurement probe 4 is a dispersion probe and can also be used to measure micrometer-level surface roughness and overall average thickness changes of semiconductor devices. The color conjugate focus measurement probe 4 utilizes the multi-wavelength characteristics of a colored light source to perform depth measurement through light reflection and scattering. Using confocal imaging dispersion analysis technology, the surface roughness of semiconductor devices can be accurately measured, and surface profile measurements, including fine curvature and structural features can be measured. The present disclosure integrates multiple measurement devices, including a fringe interferometer device 2, a white light interferometer probe 3, and a color conjugate focus measurement probe 4, into a single machine. These devices can be used separately or together, thereby facilitating precise and rapid measurement of semiconductor device processing results from various manufacturing processes. The fringe interferometer device 2 and the white light interferometer probe 3 can be used for nanometer-level measurement, particularly for measuring sliced and polished wafers. The color conjugate focus measurement probe 4 can be used for micrometer-level measurement.

### Beneficial Effects of the Embodiments

In conclusion, the integrated multiplexing measurement system provided by the present disclosure includes a main body, a fringe interferometer device, a white light interferometer probe, and a color conjugate focus measurement probe. The fringe interferometer device, the white light interferometer probe, and the color conjugate focus measurement probe are disposed in the main body, and the white light interferometer probe and the color conjugate focus measurement probe are disposed adjacent to each other. The fringe interferometer device, the white light interferometer probe, and the color conjugate focus measurement probe can be separately used to measure semiconductor devices.

Furthermore, in the present disclosure, multiple measurement devices are integrated into a single machine, thereby facilitating the semiconductor device measurement operation and simplifying the semiconductor device conveying process, enabling rapid completion of multiple measurement operations for the semiconductor device. Measurement can be performed in-line to facilitate automated production, and semiconductor devices can be measured after different processes, so as to achieve comprehensive measurement results to enhance production efficiency, process analysis, and yield improvement. This effectively addresses issues in conventional measurement processes such as poor object conveying lines, insufficient object measurement data, and the difficulty in improving production efficiency and process yield.

Moreover, the fringe interferometer device of the present disclosure is disposed near one side of the main body, and the white light interferometer probe and the color conjugate focus measurement probe are disposed near another side of the main body. The main body is rectangular-shaped, and two opposite sides of the main body are respectively defined as a first side and a second side. The fringe interferometer device is located adjacent to the first side of the main body, and the white light interferometer probe and the color conjugate focus measurement probe are located adjacent to the second side of the main body. Another two opposite sides of the main body are respectively defined as a third side and a fourth side. The third side or the fourth side may be an opening. The white light interferometer probe and the color conjugate focus measurement probe are spaced apart from the fringe interferometer device, and the fringe interferometer device is disposed in the main body away from the white light interferometer probe and the color conjugate focus measurement probe. The above-described layout allows the fringe interferometer device, the white light interferometer probe, and the color conjugate focus measurement probe to form an optimal configuration to facilitate the transport and placement of semiconductor devices, simplify the transport process of semiconductor devices, and enable various measurement operations for semiconductor devices to be quickly completed.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An integrated multiplexing measurement system for measuring semiconductor devices, and the integrated multiplexing measurement system comprising:
a main body;
a fringe interferometer device, wherein the fringe interferometer device is disposed in the main body and used to measure the semiconductor devices;
a white light interferometer probe, wherein the white light interferometer probe is disposed in the main body and used to measure the semiconductor devices; and
a color conjugate focus measurement probe, wherein the color conjugate focus measurement probe is disposed in the main body and is used to measure the semiconductor devices; and wherein the white light interferometer probe is disposed adjacent to the color conjugate focus measurement probe.

2. The integrated multiplexing measurement system according to claim 1, wherein the fringe interferometer device is disposed in the main body and adjacent to one side of the main body, and the white light interferometer probe and the color conjugate focus measurement probe are disposed in the main body and adjacent to another side of the main body.

3. The integrated multiplexing measurement system according to claim 1, wherein the main body is rectangular-shaped, and two opposite sides of the main body are respectively defined as a first side and a second side; wherein the fringe interferometer device is located adjacent to the first side of the main body, and the white light interferometer probe and the color conjugate focus measurement probe are located adjacent to the second side of the main body; and wherein another two opposite sides of the main body are respectively defined as a third side and a fourth side, and the third side or the fourth side is an opening.

4. The integrated multiplexing measurement system according to claim 1, wherein the white light interferometer probe and the color conjugate focus measurement probe are spaced apart from the fringe interferometer device, and the fringe interferometer device is disposed in the main body at a position away from the white light interferometer probe and the color conjugate focus measurement probe.

5. The integrated multiplexing measurement system according to claim 1, wherein a first workbench is disposed below the fringe interferometer device, and the first workbench is used for placing the semiconductor devices; and wherein a second workbench is provided below the white light interferometer probe and the color conjugate focus measurement probe, and the second workbench is used for placing the semiconductor devices.

6. The integrated multiplexing measurement system according to claim 1, the fringe interferometer device is used to measure at least one of warpage, concavity and convexity, color, brightness distribution, shape, and distribution of high-nitrogen areas of the semiconductor devices.

7. The integrated multiplexing measurement system according to claim 1, the white light interferometric probe is used to measure at least one of surface roughness, surface depth, and micro-changes of the semiconductor devices.

8. The integrated multiplexing measurement system according to claim 1, wherein the color conjugate focus measurement probe is used to measure at least one of surface roughness, thickness changes, and surface profile of the semiconductor devices.

9. The integrated multiplexing measurement system according to claim 1, wherein the integrated multiplexing measurement system is applied in the front-end process of compound semiconductors.
